(19) United States
(12) Patent Application Publication
(10) Pub. No.: US 2010/0151219 A1
(43) Pub. Date: Jun. 17, 2010

(54) SIMULTANEOUSLY ORIENTED PLA FILM WITH IMPROVED MECHANICAL PROPERTIES

(75) Inventors: Detlef Busch, Saarlouis (DE); Bertram Schmitz, Sarreguemines (FR)

Correspondence Address: CONNOLLY BOVE LODGE & HUTZ, LLP, P O BOX 2207, WILMINGTON, DE, 19899, US

(73) Assignee: Treofan Germany GmbH & Co., KG, Neunkirchen (DE)

(21) Appl. No.: 12/444,414

(22) PCT Filed: Sep. 22, 2007
(86) PCT No.: PCT/EP2007/008263

§ 371 Date: Dec. 31, 2009

(30) Foreign Application Priority Data
Oct. 5, 2006 (DE) 10 2006 047 059.1

(51) Int. Cl. B32B 27/28; B29C 47/00

(52) U.S. Cl. 428/220; 428/337; 264/210.1

(57) ABSTRACT

The present invention relates to a biaxially oriented polyhydroxycarboxylic acid film composed of at least one layer containing a polymer based on hydroxycarboxylic acid. The film is notable for good mechanical properties such as high breaking strength and modulus of elasticity. The invention further relates to a process for producing the PHC film and the use thereof.

The present invention relates to a biaxially oriented polyhydroxycarboxylic acid film comprising at least one layer comprising a polymer based on hydroxycarboxylic acids. The invention further relates to a process for producing the PHC film and the use thereof.

Films made of thermoplastic materials are used to an ever increasing extent for packaging foodstuffs and other packaged goods. In the meantime, the disposal of these materials presents a similarly increasing problem. The development of recycling systems is troublesome, the systems have a questionable efficiency and are frequently only regionally realized, for example in Germany. Crude oil as the natural starting material of the polyolefinic thermoplastic materials is available in limited quantities. These circumstances led to the development of packaging material made of raw materials that grow back and can be composted. Examples are polymers and copolymers of lactic acids and other aliphatic hydroxycarboxylic acids.

Besides the raw materials, film products made from these raw materials are also known in prior art. Due to high raw material costs, these products are often not competitive compared to conventional polymer films. For cost reasons, thin films made of raw materials that grow back and can be composted are therefore especially desirable. Naturally, the important performance characteristics such as for example constant machine runability, stiffness, barrier properties, thickness profile, processability, etc. may not be affected.

However, thinner films always have in principle a disproportionately poorer stiffness in the machine direction and hence significantly poorer running characteristics on today's high-speed wrapping machines. The stiffness (S) of a film is proportional to the modulus of elasticity (E) and the third power of the thickness (d) [S=E·d³]. In case of thinner films, the only possibility to compensate for the loss of stiffness is therefore by means of the elastic modulus of the film. Increasing the modulus of elasticity (E modulus) in the machine direction has therefore been the purpose of intense efforts for a long time.

It is known of boPP films that the modulus of elasticity in the machine direction can be increased either by means of the process technology or by means of raw material modifications or the combination of both possibilities, for example by means of a three- or multi-stage stretching process. However, such a production method has the disadvantage that it requires an additional device for longitudinal post-stretching and it is therefore very costly. In addition, interruptions of the production process, for example tearing of the film, occur more frequently. Furthermore, such longitudinally post-stretched boPP films exhibit, compared to only biaxially oriented films, noticeably increased longitudinal shrinkage that normally prevents the film from withstanding thermal drying, which is to some extent still common practice, for example after application of adhesive substances, without developing undesirable shrinkage folds.

Similarly, to achieve universal applicability of the film, the tear strength in the longitudinal direction needs to be improved since the tear strength essentially determines the usability of the film in the various applications. However, similar to the modulus of elasticity, sequentially oriented films have low tear strength particularly in the longitudinal direction.

U.S. Pat. No. 5,443,780 describes for example the production of oriented films made of PLA. The process starts with a PLA melt, which is extruded and rapidly cooled down. Subsequently, this pre-film can be subjected to a uniaxial stretching process or it can be sequentially or simultaneously biaxially oriented. The stretching temperature is between the glass transition temperature and the crystallization temperature of the PLA. By means of orienting the film, an increased strength and a higher Young's modulus of the final film are achieved. It is not specified which film thicknesses can be produced by this method. It is not specified which kind of simultaneous stretching method can be employed. In each case, the figures show that the increase of the mechanical strengths in the longitudinal direction is achieved at the expense of the respective strength in the transverse direction. Although the improved strength in the machine direction is quite desirable, the film becomes completely unusable in this case because of much too low values in the transverse direction. According to this teaching, the maximum stretch factors possible are 3.5 in case of a monoaxial orientation and 2.5*2.5 in case of orientation in both directions.

EP 1 153 743 describes a biodegradable bag made of a laminate. The laminate is produced by heat sealing of two films, one of the two films being composed of an aliphatic polyester, for example of PLA. It is described that these PLA films can be produced by biaxial orientation, all methods possible in principle to orient a film being specified. It is not specified which film thicknesses can be produced by means of simultaneous stretching methods. According to the description, stretch factors between 1.5 and 6 are possible for orientation in the longitudinal and transverse direction. According to the example, in the sequential biaxial orientation it is stretched to 3*3.

In general, it is desirable in the production of a biaxially oriented film made of thermoplastic polymers to apply the maximum stretch factors possible. On the one hand, the higher the stretch factors, the higher the yield of oriented film; on the other hand, the quality of the film is improved. The higher the stretch factors, the higher the mechanical strength achieved by orientation. However, thermoplastic polymers cannot be oriented in any way or without limits. In general, there is an apparent limit of elasticity that is inherent in every material and cannot be readily manipulated. When this limit of elasticity is exceeded, overstretching occurs, which results in tearing and stress whitening. Optionally, it is possible in biaxial orientation to reduce the stretch factor in one direction to increase the orientation in the other direction at the cost of this measure.

For PLA films, it became apparent that in a sequential orientation, stretch factors of about 2.5 to a maximum of 3 in the machine direction cannot be exceeded. Otherwise, the problem described above occurs, in particular stress whitening due to overstretching. After longitudinal stretching, it should be oriented to at least 4.5 in the transverse direction to achieve an acceptable thickness profile. Increasing the stretch factor in the transverse direction to up to 5.5-6 is possible and was realized in a sequential orientation. Hence, the maximum area stretch ratios (longitudinal stretch factor transverse stretch factor) possible so far for PLA films are a maximum of 18.

EP 0 748 273 describes a method for producing very thin films made of PET. According to this teaching, films having a thickness of less than 2.5 μm can be produced from PET raw materials by means of simultaneous orientation. According to the invention, a surprisingly good thickness profile, which is particularly critical for such thin films, may be adjusted by the simultaneous stretching method. Besides PET, no additional polymers that can be processed to biaxially oriented films using the method are specified.

It was the object of the present invention to provide environmentally friendly films and packaging, which on the one hand are made of raw materials that grow back and on the other hand can be disposed in an environmentally friendly manner. The films should have economic advantages and optimized performance characteristics for the use as packaging film, in particular good mechanical properties.

The object is solved by a biaxially oriented film composed of at least one layer comprising a polymer I made of at least one hydroxycarboxylic acid, the film having a thickness of <25 μm and being simultaneously oriented and exhibiting a tear strength in the machine direction of >120 N/mm² and in the transverse direction of >120 N/mm², the values in the machine direction and transverse direction differing by a maximum of 40% based on the value in the transverse direction.

Furthermore, the object is solved by a biaxially oriented film composed of at least one layer comprising a polymer I made of at least one hydroxycarboxylic acid, the film having a thickness of <25 μm and being simultaneously oriented and exhibiting a modulus of elasticity in the machine direction of >3,000 N/mm² and in the transverse direction of >3,000 N/mm², the values in the machine direction and transverse direction differing by a maximum of 40% based on the value in the transverse direction.

The object is further solved by a method for producing a PHC film, wherein a melt of PHC and optionally further additives is extruded, the melt is cooled to a flat film, and the cooled flat film is subsequently simultaneously oriented in the longitudinal and transverse direction, the stretch factor in the longitudinal direction being at least 4.

The object is also solved by a method for producing a PHC film, wherein a melt of PHC and optionally further additives is extruded, the melt is cooled to a flat film, and the cooled flat film is subsequently simultaneously oriented in the longitudinal and transverse direction, the area stretch ratio being at least 21.

Preferably, the tear strength of the PHC film according to the invention is in the machine direction 140 to 250 N/mm², in particular 150 to 200 N/mm², and in the transverse direction from 140 to 250 N/mm², in particular 150 to 200 N/mm². Preferably, the modulus of elasticity of the PHC film according to the invention in the machine direction is 3,200 to 6,000 N/mm², more preferably 3,500 to 5,000 N/mm², and in the transverse direction from 3,200 to 6,000 N/mm², more preferably 3,500 to 5,000 N/mm².

It was found that by simultaneous stretching, thin PHC films having a thickness of less than 25 μm can be produced. Surprisingly, these thin films have very good mechanical properties in both directions. In particular, the film exhibits unexpectedly high tear strength in the longitudinal direction, the respective strength in the transverse direction being largely maintained compared to sequentially oriented films, at least not being significantly lower. Originally, it was expected that in comparison with a sequentially oriented film, the increase of the tear strength and the increase of the modulus of elasticity in the machine direction would inevitably be accompanied by a significant negative impact on the respective values in the transverse direction. Surprisingly, this is not the case or so little pronounced that the film produced by the method according to the invention can be used without problems in the common manufacturing and application processes despite the very small thickness of less than 25 μm. The film withstands the mechanical stress occurring during these processes; surprisingly, the mechanical strengths in both directions are so good that the film can be processed trouble-free with good running characteristics.

The film according to the invention is single-layered or multi-layered. Single-layered embodiments are composed in the same manner as the PHC layer described below. Multi-layered embodiments have at least two layers and comprise several PHC layers that differ in structure and composition, the PHC layer preferably being the base layer of the multi-layered embodiment. Optionally, the intermediate or cover layer of the multi-layered film can be a PHC layer. In a preferred embodiment, the PHC layer forms the base layer of the film having at least one PHC cover layer, preferably having PHC cover layers on both sides, intermediate layer(s) optionally being present on one or both sides.

In terms of the present invention, the base layer is the layer that accounts for more than 30% up to 100%, preferably 50 to 90%, of the total film thickness and has the largest layer thickness. The cover layers are the layers that form the outer layers of the film. Intermediate layers are disposed by nature between the base layer and the cover layers.

The PHC layer, which is optionally the only layer of the film according to the invention, comprises a polymer I made of at least one hydroxycarboxylic acid and optionally further additives, each in effective quantities. This layer generally contains at least 70 up to 100% by weight, preferably 80 to <100% by weight, most preferably 80 to 98% by weight, of a polymer I made of at least one hydroxycarboxylic acid, based on the weight of the layer. Polymers I made of at least one hydroxycarboxylic acid are homopolymers or mixed polymers that are composed of polymerized units of, preferably aliphatic, hydroxycarboxylic acids. Among the PHC suitable for the present invention are in particular polylactic acids. These are referred to as PLA below. The term PLA refers here also to both homopolymers, which are composed only of lactic acid units, and mixed polymers, which contain predominantly lactic acid units (>50%) in combination with other aliphatic hydroxycarboxylic acid units.

Suitable as monomers of aliphatic polyhydroxycarboxylic acids (PHC) are in particular aliphatic mono-, di-, or trihydroxycarboxylic acids or dimeric cyclic esters thereof, among which lactic acid in its D- or L-form is preferred. A suitable PLA is for example polylactic acid from Cargill Dow (NatureWorks®). The production of polylactic acid is known in prior art and occurs via catalytic ring opening polymerization of lactide (1,4-dioxane-3,6-dimethyl-2,5-dione), the dimeric cyclic ester of lactic acid; PLA is therefore often referred to as polylactide. In the following publications, the production of PLA is described—U.S. Pat. No. 5,208,297, U.S. Pat. No. 5,247,058, or U.S. Pat. No. 5,357,035.

Polylactic acids composed solely of lactic acid units are preferred. PLA homopolymers comprising 80-100% by weight of L-lactic acid units, corresponding to to 20% by weight of D-lactic acid units, are particularly preferred. To reduce the crystallinity, even higher concentrations of D-lactic acid units as comonomer may also be comprised. Optionally, the polylactic acid can additionally have aliphatic hydroxycarboxylic acid units different from lactic acid as comonomer, for example glycolic acid units, 3-hydroxypropionic acid units, 2,2-dimethyl-3-hydroxypropionic acid units, or higher homologs of hydroxycarboxylic acids having up to 5 carbon atoms.

Lactic acid polymers (PLA) having a melting point of 110 to 170° C., preferably from 125 to 165° C., and a melt flow index (measured according to DIN 53 735 with a 2.16 N load and at 190° C.) of 1 to 50 g/10 min, preferably from 1 to 30 g/10 min, are preferred. The molecular weight of the PLA is in a range from at least 10,000 to 500,000 (number average), preferably 50,000 to 300,000 (number average). The glass transition temperature Tg is in a range from 40 to 100° C., preferably 40 to 80° C.

In a further embodiment, the film can additionally comprise in at least one PHC layer cycloolefin copolymers (COC) in a quantity of at least 0.5% by weight, preferably 1 to 30% by weight, and most preferably 5 to 20% by weight, based on the weight of the PHC layer or based on the weight of the film in case of single-layered embodiments. Such embodiments are opaque and have a reduced density.

In terms of the present invention, a reduced density of the opaque PHC films refers to a film, the density of which is below the density calculated from the composition and the density of the starting materials. A reduced density for PLA films is a density of <1.25 g/cm³.

In terms of the present invention, an opaque, biaxially oriented PHC film refers to a film having a degree of whiteness of at least 10%, preferably more than 20%, and an opacity of more than 20%, preferably more than 25%. The luminous transmittance according to ASTM-D 1003-77 of such opaque films is generally less than 95%, preferably less than 75%.

The COC added to the PHC layer generally has a Tg of 70 to 270° C. In a preferred embodiment of the film according to the invention, the glass transition temperature of the COCs used is in a range from 90 to 200° C., and in the particularly preferred embodiment in a range from 110 to 160° C.

Cycloolefin copolymers are homopolymers or copolymers composed of polymerized cycloolefin units and optionally acyclic olefins as comonomer. Cycloolefin polymers comprising 0.1 to 100% by weight, preferably 10 to 99% by weight, particularly preferably 50-95% by weight, each based on the total mass of the cycloolefin polymer, of polymerized cycloolefin units are suitable for the present invention. Particularly suitable cycloolefin polymers are described in detail in EP 1 068 949, which is hereby explicitly referenced.

Among the cycloolefin copolymers described above and in EP 1 068 949, in particular those comprising polymerized units of polycyclic olefins having a norbornene basic structure, especially norbornene or tetracyclododecene, are preferred. Cycloolefin copolymers (COC) comprising polymerized units of acyclic olefins, in particular ethylene, are also particularly preferred. Again, norbornene/ethylene and tetracyclododecene/ethylene copolymers comprising 5 to 80% by weight, preferably 10 to 60% by weight of ethylene (based on the weight of the copolymer) are especially preferred.

The cycloolefin polymers generically described above and in EP 1 068 949 generally have glass transition temperatures between 100° C. and 400° C. Cycloolefin copolymers (COC) having a glass transition temperature of greater than 70° C., preferably greater than 90° C., and most preferably greater than 110° C., can be used in the invention. The viscosity number (Dekalin, 135 DEG C, DIN 53 728) is advantageously between 0.1 and 200 ml/g, preferably between 50 and 150 ml/g.

The cycloolefin copolymers are incorporated into the film either as pure granulate or as granulated concentrate (masterbatch) by pre-mixing the granulate of PHC, preferably PLA, with the cycloolefin copolymer (COC) or the cycloolefin copolymer (COC) masterbatch and subsequently feeding it to the extruder. In the extruder, the components are mixed further and heated to the processing temperature. It is advantageous for the method according to the invention that the extrusion temperature is above the glass transition temperature Tg of the cycloolefin copolymer (COC), generally at least 10° C., preferably 15 to 100° C., most preferably 20 to 150° C., above the glass transition temperature of the cycloolefin copolymer (COC).

The layers of the PHC film according to the invention may additionally comprise common additives such as neutralizing agents, stabilizers, antiblocking agents, lubricants, and other filler materials. Advantageously, they are already added to the polymer or the polymer mixture prior to melting. Phosphorous compounds, such as phosphoric acid or phosphoric acid esters, for example are used as stabilizers.

Typical antiblocking agents are inorganic and/or organic particles, for example calcium carbonate, amorphous silica, talcum, magnesium carbonate, barium carbonate, calcium sulfate, barium sulfate, lithium phosphate, calcium phosphate, magnesium phosphate, aluminum oxide, carbon black, titanium dioxide, kaolin, or crosslinked polymer particles, for example polystyrene, acrylate, PMMA particles or crosslinked silicones. Muscovite mica having an average particle size (weighted average) of 4.0-12 μm, preferably 6 to 10 μm, is also particularly suitable. As is generally known, mica consists of platelet-like silicates, the aspect ratio of which is preferably in the range from 5 to 50. The antiblocking agent concentration is generally 0.01 to a maximum of 1% by weight, based on the weight of the cover layer; transparent embodiments should not comprise more than 0.5% by weight with regard to low haze. Mixtures of two and more different antiblocking agents or mixtures of antiblocking agents having the same composition but a different particle size can also be chosen as additives. The particles can be added directly or by means of masterbatches to the polymers of the individual layers of the film in the respective advantageous concentrations during extrusion. Antiblocking agents are preferably added to the cover layer(s).

Glycerin fatty acid esters wherein one, two, or all three alcohol functions are esterified with a fatty acid are particularly suitable as antistatic agents. Monoesters wherein only one alcohol group of the glycerin is esterified with a fatty acid, so-called glycerin monofatty acid esters, are preferred. Suitable fatty acids of these compounds have a chain length of 12 to 20 C atoms. Stearic acid, lauric acid, or oleic acid is preferred. Glycerin monostearate (GMS) has proven to be particularly advantageous. Glycerin fatty acid ester is preferably used in the cover layer and in particular in a quantity of 1 to 10% by weight, in particular 2 to 6% by weight. In an embodiment particularly advantageous with respect to antistatic behavior, GMS is combined with one of the antiblocking particles described above.

In a further possible embodiment, starch-based particles are added to the cover layer in a quantity of 0.01-10% by weight, in particular 0.01 to 5% by weight, based on the weight of the cover layer, to improve the antistatic and antiblocking behavior. Modified and unmodified varieties of starch, for example based on potato starch, corn starch, or wheat starch, are suitable. The original size of the particles is comparatively noncritical since the starch particles are reduced in size during film extrusion. The starch particles generally have an absolute particle size of 1 to 15 μm in the film and can have any regular or irregular particle shape.

For white embodiments of the PHC film, the PHC layer or at least one of the additional layers, optionally even the opaque PHC layer, can additionally comprise a pigment. Pigments are for example barium sulfate, preferably with an average particle size of 0.3-0.8 μm, more preferably 0.4-0.7 μm, or titanium dioxide, preferably with an average particle size of 0.05-1 μm. Through this, the film obtains a brilliant, white appearance. The pigmented layer generally comprises in these embodiments 1 to 25% by weight, preferably more than 1 to 20% by weight, and most preferably 1 to 15% by weight of pigments, in each case based on the weight of the layer.

According to the invention, the total thickness of the film is <25 μm, preferably 5-20 μm, most preferably 8 to 18 μm. The thickness of the optionally present intermediate layer(s) is generally independently of each other 0.5 to 3 each. The thickness of the cover layer(s) is chosen independently of the other layers and is preferably in the range of 0.1 to 4 μm, in particular 0.2 to 3 μm, cover layers applied on both sides being either the same or different with respect to thickness and composition. The thickness of the base layer results accordingly from the difference of the total thickness of the film and the thickness of the applied cover and intermediate layer(s) and therefore can vary within wide limits analogous to the total thickness.

The different embodiments of the film according to the invention described above can be used as substrate for a subsequent metallization. In this connection, in particular such embodiments that are metallized on the surface of a COC-containing layer, i.e. single-layered embodiments and those with an appropriate COC-containing layer as cover layer, have proven to be particularly advantageous. It was found that layers of COC and polymer made of at least one hydroxycarboxylic acid have particularly good metal adhesion.

Furthermore, the described film can be used as label film and as packaging film for packaging foodstuffs and durable goods. Due to advantageous twist wrap properties PLA film is known to exhibit, the film is also very well suited for twist wrap packaging for hard candy, tampons and the like.

Furthermore, the invention relates to a method for producing the PHC film, preferably PLA film. In the description of the method according to the invention below, all explanations refer to both the production of a PHC film in general and a method for producing the preferred PLA films. In this sense, the term film comprises both PHC films and PLA films. According to the invention, the film is produced by means of a simultaneous stretching method. In terms of the present invention, simultaneous stretching methods comprise methods in which the film melt is first extruded through a flat film extrusion die and subsequently simultaneously oriented in the longitudinal and transverse direction by means of suitable devices. Such methods and devices for executing the method are known in prior art for example as LISIM or MESIM (mechanical simultaneous orientation) methods. LISIM methods are described in detail in EP 1 112 167 and EP 0 785 858, which are hereby explicitly referenced. A MESIM method is described in US 2006/0115548, which is also explicitly referenced. In a further but nor preferred embodiment, the film can also be produced as blown film since in this method, a simultaneous orientation in the longitudinal and transverse direction takes place as well.

Within the scope of the simultaneous stretching method according to the invention, the procedure involves extruding/coextruding the melt(s) corresponding to the single-layered film or the individual layers of the film through a flat film extrusion die, cooling the extruded melt on one or more rollers at a temperature of 10 to 100° C., preferably 30 to 80° C., for solidification and taking it off. Subsequently, this pre-film or flat film is biaxially oriented, the biaxially oriented film is heat-set and optionally plasma-, corona-, or flame-treated on the surface layer intended for treatment.

According to the invention, the biaxial orientation is performed simultaneously. In the process, the film is simultaneously oriented in the longitudinal direction (i.e. in the machine direction=MD) and in the transverse direction (i.e. perpendicular to the machine direction=TD). This results in an orientation of the molecular chains.

According to the LISIM© method, the simultaneous orientation occurs by a continuous simultaneous stretching method. The film is conveyed in a stretching oven using a transport system working according to the LISIM© method. The film edges are gripped by so-called clips driven by means of a linear motor. Individual clips, for example every third clip, are equipped with permanent magnets and simultaneously serve as secondary part of a linear motor drive. Over almost the entire continuous transport path, the primary parts of the linear motor drive are disposed parallel to the guide rail. The clips, which are not driven, only serve to absorb the film forces perpendicular to the running direction and to reduce the sagging between the holding points.

After the film edges have been gripped by the clips, the pre-film passes through a preheating zone in which the guide rails of the clips run essentially in parallel. In this section of the stretching oven, the pre-film is heated from the inlet temperature to the stretching temperature by means of a suitable heating device, for example a convection heater or an IR radiator. Afterwards, the simultaneous stretching process starts by accelerating the clip carriages, which are independent of one another, in the film direction and thereby separating them, i.e. increasing their distance with respect to each other. In this way, the film is stretched in length. Simultaneously, transverse stretching takes place on top of this process, namely because the guide rails diverge in the area of the clip acceleration.

Afterwards, the film is set with regard to the desired mechanical film properties. A heat setting treatment occurs at an elevated temperature, in which the film optionally relaxes slightly in a controlled manner in the longitudinal or transverse direction in the clamped state. Simultaneous relaxing in the longitudinal and transverse direction can be especially advantageous. Here, the clip carriages are decelerated, whereby their distance with respect to each other is reduced. Simultaneously, the guide rails of the transport system are allowed to converge slightly.

In the MESIM® method, the simultaneous orientation occurs according to a principle equivalent to the LISIM method. The film is also conveyed in a stretching oven using a transport system of clips on guide rails. Here, on each film edge, there is a pair of rails on which opposing clips and clip-like elements are disposed and connected with one another by means of a scissor-type joint. The distance of the clips with respect to one another can be varied by means of the scissor-type joint. By pulling the scissor-type joint apart, the distance of the clips with respect to one another is increased. Reversely, the distance is reduced when the joint is closing. In the stretching oven, the two guide rails of each pair of rails (with scissor-type joint) are disposed in a converging manner whereby the scissor-type joint is pulled apart and the clips accelerate in the running direction of the film and increase their distance with respect to each other. The film is hereby stretched in length. Simultaneously, due to the diverging arrangement of the pairs of rails, a simultaneous stretching in the transverse direction occurs at each film edge.

During orientation according to the LISIM or MESIM method described above, the film is generally heated in a preheating zone to a stretching temperature between the glass transition temperature and the melting point of the polyhydroxycarboxylic acid. For PLA films, a temperature range of 60-150° C. is preferred, more preferably 70-110° C., most preferably 80-100° C., in which the simultaneous orientation finally occurs. The stretch ratios may be flexibly chosen, so that the film can comply with different requirements depending on the field of application. Surprisingly, the longitudinal stretch factor may be increased to up to 6, more preferably to up to 5.5, in a simultaneous orientation and is hence significantly above the longitudinal stretch factors technically realizable in a sequential orientation. The stretch factor in the longitudinal direction is preferably 3 to 6, more preferably 4 to 5.5. Despite this surprisingly high longitudinal orientation, it is possible at the same time to maintain the known stretch factors in the transverse direction of up to 7, more preferably 5 to 6. The stretch factor in the transverse direction is preferably 4 to 7, more preferably 5 to 6. Area stretch ratios of up to 42 can therefore be realized. Such area stretch ratios are not even close to being achievable in a sequential orientation.

Hence, it is both surprising that a significantly higher longitudinal orientation of PHC or PLA is possible by means of simultaneous orientation and particularly surprising that a high longitudinal orientation can be combined with comparatively high transverse stretch factors. The simultaneous orientation therefore allows area stretch ratios that have not been achievable thus far for biaxially oriented PLA films and that are in the range of 20 to 40, more preferably in the range from 25 to 35.

The stretching of the film is followed by the described heat setting (heat treatment) in which the film is maintained for about 0.1 to 10 s at a temperature of 60 to 150° C. Subsequently, the film is wound up in customary fashion by means of a winding device.

Optionally, the film can be coated to adjust further properties. Typical coatings are adhesion-promoting, antistatic, slip-improving, or dehesive-acting layers. Optionally, these additional layers can be applied by means of in-line coating using aqueous dispersions prior to transverse orientation or off-line.

The film according to the invention is characterized by outstanding mechanical properties in the longitudinal and transverse direction and outstanding running characteristics during the production process and by a high modulus of elasticity and good tear strength in the machine and transverse direction. It is superbly suitable for packaging foodstuffs and semi-luxury food. Aside from that, it is also suitable for use in the industrial sector, for example in the production of embossed films or as label film. Embodiments that exhibit vacuole-like hollow spaces due to the addition of COC have a reduced density, which is in the range of 0.6 to 1 g/cm³.

According to the invention, the mechanical strengths of the film in the transverse direction are not significantly higher than in the longitudinal direction, as is the case with sequentially oriented films. Generally, the difference of the tear strength or the modulus of elasticity and/or the shrinkage in the longitudinal and transverse direction is ±40%, preferably >0 to ±30%, more preferably ±2 to ±25%, each based on the respective value in the transverse direction, whereas the respective difference in sequentially oriented films generally is at least—45%, i.e. the tear strength or modulus of elasticity or the shrinkage is in the longitudinal direction at least 45% less than in the transverse direction in these sequentially oriented films.

For the characterization of the raw materials and films, the following measured values were used:

Shrinkage:

The longitudinal and transverse shrinkage values are based on the respective linear extension of the film (longitudinal L0 and transverse Q0) prior to the shrinkage process. The longitudinal direction is the machine direction; the direction at right angle to the machine run is correspondingly defined as the transverse direction. The film specimen of 10 cm*10 cm is shrunk in a circulating air oven at 100° C. over a period of 5 min. Subsequently, the remaining linear extensions of the specimen are determined again longitudinally and transversely (L1 and Q1). The difference of the determined lengths relative to the original length L0 and Q0 times 100 is given as shrinkage in %.

longitudinal shrinkage Lₛ[%]=(L₀−L₁)/L₀*100[%]

transverse shrinkage Qₛ[%]=(Q₀−Q₁)/Q₀*100[%]

This determination method for the longitudinal and transverse shrinkage is in accordance with DIN 40634.

Tear Strength, Elongation at Break

The tear strength [N/mm²] and the percentage elongation at break were measured in accordance with DIN 53 455 (tensile strength test) using the tensile tester made by Zwick (Zwick 1435).

### Modulus of Elasticity

The modulus of elasticity is determined in accordance with DIN 53 457 (tensile strength test) 14 days after production. The tensile tester made by Zwick was used as well.

Glass Transition Temperature

The glass transition temperature Tg was determined with film samples using DSC (Differential Scanning Calorimetry) (DIN 73 765). A DSC 1090 from DuPont was used. The heating rate was 20 K/min and the initial weight was about 12 mg. In the first heating operation, the glass transition temperature Tg was determined. The samples frequently showed enthalpy relaxation (a peak) at the beginning of the step-like glass transition. The temperature at which the step-like change of the heat capacity—independent of the peak-shaped enthalpy relaxation—reached half its height in the first heating operation was used as Tg. In all cases, only a single glass transition step was observed in the thermogram during the first heating.

Below, the invention is explained by means of exemplary embodiments.

### EXAMPLE 1

A three-layered PLA film having a thickness of 18 μm was produced by extrusion and subsequent simultaneous orientation on a LISIM unit. The base layer was composed to about 100% by weight of a semicrystalline polylactic acid raw material (4042D from NatureWorks® having a melting point of 145° C. and a melt flow index of about 3 g/10 min at 210° C. and a glass transition temperature of 60° C.). The polylactic acid raw material 4042D from NatureWorks® was also used to 100% as cover layer raw material. The thickness of the individual cover layers was 3 μm. The layers additionally comprised stabilizers and neutralizing agents in customary quantities. The production conditions in the individual process steps were:

| Extrusion: | temperatures | 170-200° C. |
|---|---|---|
| | temperature of the | 30° C. |
| | take-off roll: | |
| Stretching temperature | | 92° C. |
| in the LISIM frame: | | |
| | longitudinal | 4.5 |
| | stretch ratio: | |
| | transverse stretch | 5.5 |
| | ratio (effective): | |
| Setting: | temperature: | 135° C. |

### EXAMPLE 2

A film having the same composition as described in Example 1 was produced. Analogous to the procedure described in Example 1, a three-layered PLA film having a thickness of only 14 μm was produced by extrusion and subsequent simultaneous orientation on a LISIM unit:

| Extrusion: | temperatures | 170-200° C. |
|---|---|---|
| | temperature of the | 30° C. |
| | take-off roll: | |
| Stretching temperature | | 88° C. |
| in the LISIM frame: | | |
| | longitudinal | 4.5 |
| | stretch ratio: | |
| | transverse stretch | 5.5 |
| | ratio (effective): | |
| Setting: | temperature: | 135° C. |

### COMPARATIVE EXAMPLE 1

A three-layered PLA film having a thickness of 30 μm was produced by extrusion and subsequent stepwise orientation, which was first performed in the longitudinal direction and then in the transverse direction. The base layer was composed to about 100% by weight of a semicrystalline polylactic acid raw material (4042D from NatureWorks®) having a melting point of 145° C. and a melt flow index of about 3 g/10 min at 210° C. The polylactic acid raw material (4060D from NatureWorks®) was used as cover layer raw material. The thickness of the individual cover layers was 3 μm. The layers additionally comprised stabilizers and neutralizing agents in customary quantities. The production conditions in the individual process steps were: The longitudinal stretch ratio specified corresponds to the maximum longitudinal stretch ratio achievable without tearing or stress whitening.

| | | |
|---|---|---|
| Extrusion: | temperatures | 170-200° C. |
| | temperature of the | 30° C. |
| | take-off roll: | |
| Longitudinal | temperature: | 68° C. |
| stretching: | maximum longitudinal | 2.5 |
| | stretch ratio: | |
| Transverse | temperature: | 78° C. |
| stretching: | transverse stretch | 5.5 |
| | ratio (effective): | |
| Setting: | temperature: | 135° C. |

The properties of the films according to the examples and the comparative example are summarized in the table below:

TABLE 1

| | Ex. 1 | Ex. 2 | CE 1 |
|---|---|---|---|
| Thickness μm | 18 | 14 | 30 |
| E modulus MD N/mm² | 3,650 | 4,460 | 2,800 |
| E modulus TD N/mm² | 4,200 | 4,250 | 4,200 |
| Difference MD/TD in % | −15% | +5% | −33% |
| Tear strength MD N/mm² | 153 | 165 | 90 |
| Tear strength TD N/mm² | 196 | 172 | 200 |
| Difference MD/TD in % | 21% | 4% | 55% |
| Elongation at break MD % | 105 | 110 | 190 |
| Elongation at break TD % | 76 | 71 | 80 |
| Shrinkage MD/% | 4 | 4 | 3 |
| Shrinkage TD/% | 4 | 4 | 5 |

1. A biaxially oriented film composed of at least one layer comprising a polymer I made of at least one hydroxycarboxylic acid, characterized in that the film has a thickness of <25 μm and is simultaneously oriented and exhibits a tear strength in the machine direction of >120 N/mm² and in the transverse direction of >120 N/mm², the values in the machine direction and transverse direction differing by a maximum of 40% based on the value in the transverse direction.

2. A biaxially oriented film composed of at least one layer comprising a polymer I made of at least one hydroxycarboxylic acid, characterized in that the film has a thickness of <25 μm and is simultaneously oriented and exhibits a modulus of elasticity in the machine direction of >3,000 N/mm² and in the transverse direction of >3,000 N/mm², the values in the machine direction and transverse direction differing by a maximum of 40% based on the value in the transverse direction.

3. A film according to claim 1 or claim 2, characterized in that the tear strengths in the machine direction and in the transverse direction differ by no more than 35% based on the value in the transverse direction.

4. A film according to claim 1 or claim 2, characterized in that the moduli of elasticity in the machine direction and in the transverse direction differ by no more than 35% based on the value in the transverse direction.

5. A film according to any one of claims 1 to 4, characterized in that the cycloolefin copolymer (COC) has a glass transition temperature in the range of 80 to 200° C.

6. A film according to any one of claims 1 to 5, characterized in that polymer I made of at least one hydroxycarboxylic acid is composed of aliphatic hydroxycarboxylic acid units, preferably of lactic acid units.

7. A film according to any one of claims 1 to 6, characterized in that the polymer I made of aliphatic hydroxycarboxylic acid units, preferably of lactic acid units, has a melting point of 110-170° C. and a melt flow index of 1-50 g/10 min.

8. A film according to any one of claims 1 to 7, characterized in that the layer comprises 1 to 25% by weight of pigments, preferably TiO₂, in each case based on the weight of the layer.

9. A film according to any one of claims 1 to 8, characterized in that the PHC layer forms the base layer of the film and a cover layer is applied in addition to one or both sides of the base layer, said cover layer(s) being composed of at least one polymer I made of at least one hydroxycarboxylic acid.

10. A film according to claim 9, characterized in that between the PHC base layer and the cover layer(s), intermediate layer(s) are disposed on one or both sides.

11. A film according to any one of claims 1 to 8, characterized in that the film is single-layered and consists of the PHC layer.

12. A film according to any one of claims 1 to 10, characterized in that the PHC layer forms a cover layer or an intermediate layer of the film.

13. A film according to one or more of claims 1 to 10, characterized in that the film has PHC intermediate layers on both sides.

14. A film according to one or more of claims 1 to 13, characterized in that the film has a density of less than 1.25 g/cm³, preferably 0.6 to 1 g/cm³.

15. A film according to one or more of claims 1 to 14, characterized in that the film is metallized on at least one surface.

16. A film according to claim 15, characterized in that the COC-containing layer forms a cover layer of the film and this cover layer is metallized.

17. The use of a film according to any one of claims 1 to 16 as packaging film, as twist wrap film, or as label film.

18. A method for producing a PHC film, preferably a PLA film, characterized in that a melt of PHC, preferably PLA, and optionally further additives is extruded, the melt is cooled to a pre-film, and the cooled pre-film is subsequently simultaneously oriented in the longitudinal and transverse direction, characterized in that the stretch factor in the longitudinal direction is at least 4.

19. A method according to claim 18, characterized in that the stretch factor in the transverse direction is at least 3 to 7.

20. A method according to claim 19, characterized in that the stretching of the film occurs with a stretch factor of 4 to 6 in the longitudinal direction and with a stretch factor of 4 to 6 in the transverse direction.

21. A method for producing a PHC film, preferably a PLA film, characterized in that a melt of PHC, preferably PLA, and optionally further additives is extruded, the melt is cooled to a pre-film, and the cooled pre-film is subsequently simultaneously oriented in the longitudinal and transverse direction, characterized in that the area stretch ratio is at least 21.

22. A method according to claim 21, characterized in that the film is oriented with a stretch factor of 3 to 6 in the longitudinal direction and with a stretch factor of 3.5 to 7 in the transverse direction.

23. A method according to any one of claims 18 to 22, characterized in that the melt is extruded through a flat film extrusion die, and the simultaneous orientation occurs by means of clips that can travel on diverging guide rails and during orientation in the running direction of the film are accelerated in such a way that the distance of the clips with respect to one another increases, whereby simultaneously with the longitudinal orientation, the orientation of the film in the transverse direction occurs.

24. A method according to claim 23, characterized in that the acceleration of the clips occurs by means of controlled linear motors.

25. A method according to claim 23, characterized in that the clips are interconnected by means of a scissor-type joint and the spacing of the clips occurs by moving the scissor-type joint apart.
